(19) United States
(12) Patent Application Publication
(10) Pub. No.: US 2006/0245449 A1
(43) Pub. Date: Nov. 2, 2006

(54) Power supply via data lines in local networks

(76) Inventor: Hans-Jurgen Neuhaus, Berlin (DE)

Correspondence Address: BELL, BOYD & LLOYD, LLC, P. O. BOX 1135, CHICAGO, IL, 60690-1135, US

(21) Appl. No.: 10/550,051

(22) PCT Filed: Mar. 22, 2004
(86) PCT No.: PCT/EP04/03026

§ 371 Date: Sep. 21, 2005

(30) Foreign Application Priority Data
May 28, 2003 (DE) 103 24 373.9

(51) Int. Cl. H04L 12/66

(52) U.S. Cl. 370/463

(57) ABSTRACT

A particularly space saving and cost effective apparatus and method for supplying power to terminals via data lines of a local network with the aid of a method and a device for supplying power from a current sink via two data line pairs of a local network. Decoupling and/or coupling of a supply voltage provided by a voltage source takes place between the central point of two voltage dividers that are arranged between the two data lines of a pair.

### FIELD OF TECHNOLOGY

The present disclosure relates to a method and an apparatus for supplying power to a current sink (ED) via two data line pairs of a local area network (LAN).

### BACKGROUND

In local area networks (LAN) in which physical data transmission takes place, for example, via 4-wire data lines (twisted pairs), terminal devices are generally fed via additional wires. Due to existing installations for the purpose of using cable installations more effectively, terminal devices are typically fed via the (4) data lines without additional feed wires. This principle has been standardized for LANs by the IEEE draft P 802.3af. For example, a computer workstation networked via a LAN can be supplemented by an IP landline network terminal device fed from the LAN without the existing 8-wire standard wiring (twisted pair) being changed or extended.

When feeding via the data lines, phantom feed circuits are generally used. In this case, the feed voltage is fed into the center taps of the useful signal transformers at a low resistance. In this case, the design of the transformer must be such that the DC feed current does not bring about saturation of the transformer core. If this is ensured, the low-resistance feed voltage injection does not lead to the useful signals being influenced since the useful signals are picked up accurately at the center tap of the transformer, the feed point of the DC voltage (bridge circuit). The useful signals are in this case injected and output on the secondary side (Rx, Tx) of the respective transformer. For phantom circuits, transformers are used which have a relatively high space requirement, in particular a high physical height, and high costs compared with other electronic standard components.

EP 1085674 A1 describes a network having at least two lines and having network subscribers which is envisaged both for transmitting data and for transmitting energy via the network. The two lines in the network are designed both for data transmission between the network subscribers and for energy transmission from a voltage source to the network subscribers. The data are transmitted symmetrically and differentially via the two lines. In this case, one pole of the voltage source is coupled to the two lines, and the network subscribers are coupled to the other pole of the voltage source via another electrical connection isolated from the network. The network subscribers output the energy transmission symmetrically via the two lines in the network. The two lines are isolated from one another.

### SUMMARY

Accordingly, a space-saving and cost-effective option is presently proposed for injecting and/or outputting a feed voltage into a local area network.

Under an exemplary embodiment, a feed voltage is made available by a voltage source, being injected between the center points of two voltage dividers that are each arranged between the two data lines of a pair. One advantage of this configuration is the fact that it is a very simple and cost-effective solution for injecting a feed voltage into a local area network.

Additional features and advantages of the present invention are described in, and will be apparent from, the following Detailed Description and the figures

### BRIEF DESCRIPTION OF THE DRAWINGS

The various objects, advantages and novel features of the present disclosure will be more readily apprehended from the following Detailed Description when read in conjunction with the enclosed drawings, in which;

FIG. 1 shows an illustration of a conventional phantom circuit;

FIG. 2 illustrates a circuit arrangement for injecting and outputting a feed voltage under an exemplary embodiment.

### DETAILED DESCRIPTION

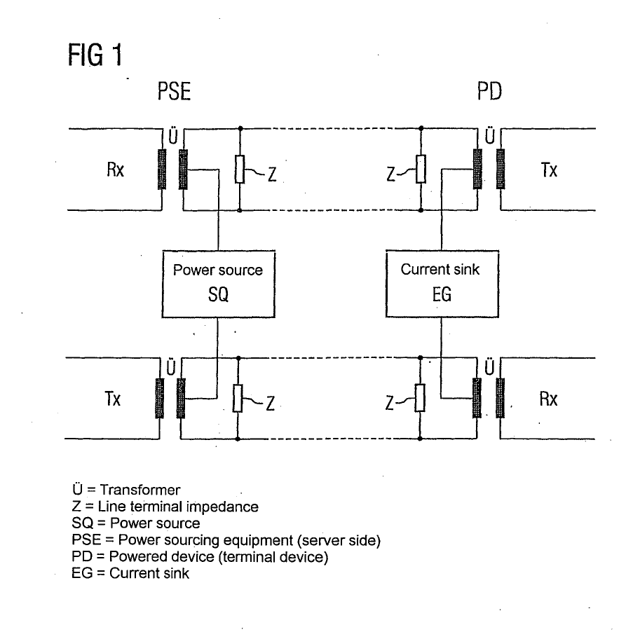

FIG. 1 shows a conventional phantom circuit. With this phantom circuit, transformers U are used by means of which a feed voltage is fed from the voltage source PSE into a data line of a network In the case of four-wire operation, Tx represents a transmission direction and Rx represents a reception direction of the data lines. The feed voltage is tapped off at a further transformer Ü of the terminal device PD and is made available to the terminal device (not illustrated in any more detail) as a feed.

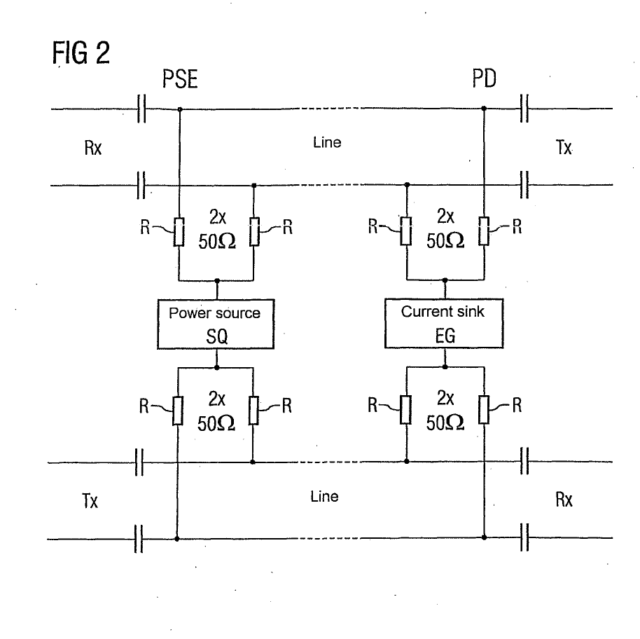

FIG. 2 shows an illustration of a circuit arrangement for injecting and/or outputting a feed voltage. When feeding via the data lines, firstly the feed voltage injection on the server side (PSE, power sourcing equipment) and the feed voltage outputting on the terminal device side (PD, powered device) are differentiated. In principle, the two sides behave in the same way. For the purpose of convenience, only the feed side (PSE) will be described below Reference will only be made to the terminal device side (PD) if necessary. Under the disclosed embodiment, the feed voltage is injected and output via nonreactive resistors R. The task of the resistors R comprises feeding in the feed voltage, for example on the feed-in side (PSE), from the low-resistance voltage source PSE into the four data lines of the local area network (LAN) such that the useful signals are not influenced. In the case of four-wire operation, Tx represents a transmission direction and Rx represents a reception direction of the data lines. The useful signals are fed in on each data line pair via the coupling capacitors. The circuit arrangement for injecting and outputting the feed voltage can in principle comprise different electronic and passive components. The problem with outputting the DC power at the terminal device (voltage sink) ED is in principle the same. A terminal device ED may be, for example, a landline terminal device (telephone), a wireless LAN base station or the like. Since modern local area networks (LAN) (for example Ethernet) having twisted pair wiring generally have a star topology, in each case 100 SZ resistors R are provided at the beginning and end for the purpose of providing AC signal termination of the data lines. These resistors are used in accordance with the invention for feeding purposes in the following way: By dividing the 100 ohm resistors R into in each case 2×50 ohm resistors R, the center point of this voltage divider is free of signals. The resistors R in the voltage divider are connected in series. The injecting and outputting of the feed voltage can therefore take place at the center point of the voltage divider without the signals being influenced.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-6. (canceled)

7. A method for supplying power to a current sink via two data line pairs of a local area network, comprising:
generating a feed voltage from a voltage source;
injecting the feed voltage between the center points of two voltage dividers that are each arranged between the two data lines of a pair, wherein two nonreactive resistors, equal in value in relation to the line termination, are used as the voltage dividers.

8. The method as claimed in claim 7 wherein the point between the two nonreactive resistors is used as the center point.

9. The method as claimed in claim 7 wherein a circuit arrangement having electronic and/or passive components is used as the voltage divider.

10. An apparatus for supplying power to at least one current sink a voltage source; via two data line pairs of a local area network, comprising:
two voltage dividers that are each arranged between the two data lines of a pair;
center points between the two voltage dividers for the purpose of injecting a feed voltage made available by the voltage source, wherein two nonreactive resistors, that are equal in value in relation to the line termination, are configured as the voltage dividers.
